(19) United States
(12) Patent Application Publication
(10) Pub. No.: US 2016/0348943 A1
(43) Pub. Date: Dec. 1, 2016

(54) WATER INLET/OUTLET REVERSIBLE WATER HEATER

(71) Applicant: EIKO ELECTRIC PRODUCTS CORP., TAIPEI CITY (TW)

(72) Inventor: Yu-Chin WANG, Taipei City (TW)

(21) Appl. No.: 14/724,832

(22) Filed: May 29, 2015

(51) Int. Cl. F24H 1/10; H05B 3/00

(52) U.S. Cl. CPC F24H 1/101; H05B 3/00

(57) ABSTRACT

A water inlet/outlet reversible water heater includes a heating tube including a tube body made from a high temperature resistant insulation material and a heating wire surrounding the tube body, a casing holding the heating tube on the inside and having a water hole in each of two opposite ends thereof for letting water pass through the axial center hole of the tube body. When water is delivered through the axial center hole of the tube body of the heating tube through an internal control, it is heated by the heating wire subject to the control of an external circuit control device, preventing the internal circuitry from thermal damage.

### BACKGROUND OF THE INVENTION

1. Field of the Invention

The present invention relates to water heating technology and more particularly, to a water inlet/outlet reversible water heater for use in an aquarium, which enables water to flow through the tube body of the heating tube thereof and to be heated by a heating element around the tube body subject to the control of a circuit control device outside a casing that holds the heating tube therein, preventing the circuitry from thermal damage.

2. Description of the Related Art

A water heater for use in an aquarium or like apparatus generally comprises a heating tube having a heating wire mounted in an inside wall of a tube body thereof. When the heating wire is electrically conducted, a heat energy is released from the heating wire and transferred through the peripheral wall of the tube body to heat the surrounding fluid (such as water), raising the temperature of the fluid (water) in the aquarium or like apparatus.

FIG. 1 illustrates a conventional water heater 10, which comprises a glass tube 12 made from a high temperature resistant insulation material, a plurality of heating wires 11 respectively wound round respective mica or ceramic strips and mounted in the glass tube 12, and a control circuit mounted in the glass tube 12 and electrically coupled with the heating wires 11.

In application, the water heater 10 is dipped in the fluid (for example, water) 15 to be heated. During operation, the heat energy released by the heating wires 11 is transferred through air in gaps 13 in the glass tube 12 and the tube wall 14 of the glass tube 12 to heat the fluid (water) 15. Conventional water heaters for aquarium commonly adopt this heating method of heating water outside the heating tube.

However, this prior art design of water heater 10 is still not satisfactory in function. Because the air exists in the gaps 13 in the glass tube 12 is a poor conductor of heat that significantly impede transfer of heat, the heat energy released by the heating wires 11 cannot be immediately and efficiently through the tube wall 14 of the glass tube 12 of high temperature resistant insulation material to heat the fluid (water) 15. Therefore, the overall heating efficiency of this prior art design of water heat is low. Further, the design of water heater is not environmentally friendly and it consumes a large amount of energy during operation. Further, during operation, the internal temperature of the water heater 10 will become high, and the related internal control circuit can be easily thermally damaged, shortening the lifespan of the water heater.

### SUMMARY OF THE INVENTION

The present invention has been accomplished under the circumstances in view. It is one object of the present invention to provide a water inlet/outlet reversible water heater, which enables water to be guided through a heating tube and directly heated by the heating tube, improving the heating efficiency of the heater. It is another object of the present invention to provide a water inlet/outlet reversible water heater, which has the operation of the heating tube be controlled by an external circuit control device, preventing the circuitry from thermal damage.

To achieve these and other objects of the present invention, a water inlet/outlet reversible water heater comprises a heating tube and a casing. The heating tube comprises a tube body made from a high temperature resistant insulation material and defining therein an axial center hole, and a heating element surrounding the outer perimeter of the tube body. The casing holds the heating tube therein having a water hole located in each of two opposite ends thereof in communication with the axial center hole of the tube body for the passing of the water to be heated. When water is guided through the water holes of the casing and the axial center hole of the tube body, it is heated efficiently and economically by the heat energy that is released by the heating element and transferred through the peripheral wall of the tube body. Further, because the related control circuit is disposed outside the heating tube, the related control circuit will not be damaged easily, and thus, the lifespan of the water inlet/outlet reversible water heater can be significantly prolonged.

Preferably, the casing comprises an axial center hole extended through two opposing ends thereof, and two end caps respectively capped on the two opposite ends thereof. Each end cap defines therein one water hole in communication with the axial center hole of the tube body of the heating tube. The tube body of the heating tube comprises two positioning portions respectively extended from two opposite ends thereof and positioned in the axial center hole of the casing, and a plurality of gasket rings respectively mounted around the positioning portions and abutted against an inside wall of the casing to seal the gap between the casing and the tube body of the heating tube.

Preferably, the water inlet/outlet reversible water heater further comprises a circuit control device fastened to an outside wall of the casing outside the heating tube, and adapted for controlling the operation of the heating element of the heating tube.

Preferably, the circuit control device comprises a power cable located at one end thereof for connection to an external power source, a circuit board mounted on the inside, opposing water-sealing bottom cover and top cover respectively covered on opposing top and bottom sides thereof in a watertight manner, and a plurality of plug holes for the mounting of the casing. Further, the casing comprises a plurality of plug rods extended from the periphery thereof and respectively plugged into the plug holes of the control circuit device, and a plurality of gasket rings mounted in between the plug rods and the plug holes.

In another embodiment of the present invention, the water inlet/outlet reversible water heater comprises a heating tube, a casing, and a circuit control device. The heating tube comprises a tube body made from a high temperature resistant insulation material and defining therein an axial center hole, and a heating element surrounding the outer perimeter of the tube body. The casing holds the heating tube therein, having a water hole located in each of two opposite ends thereof in communication with the axial center hole of the tube body for the passing of the water to be heated. The circuit control device fastened to an outside wall of the casing outside the heating tube, and adapted for controlling the operation of the heating element of the heating tube.

### BRIEF DESCRIPTION OF THE DRAWINGS

FIG. 1 is a schematic elevational view of a water heater according to the prior art.

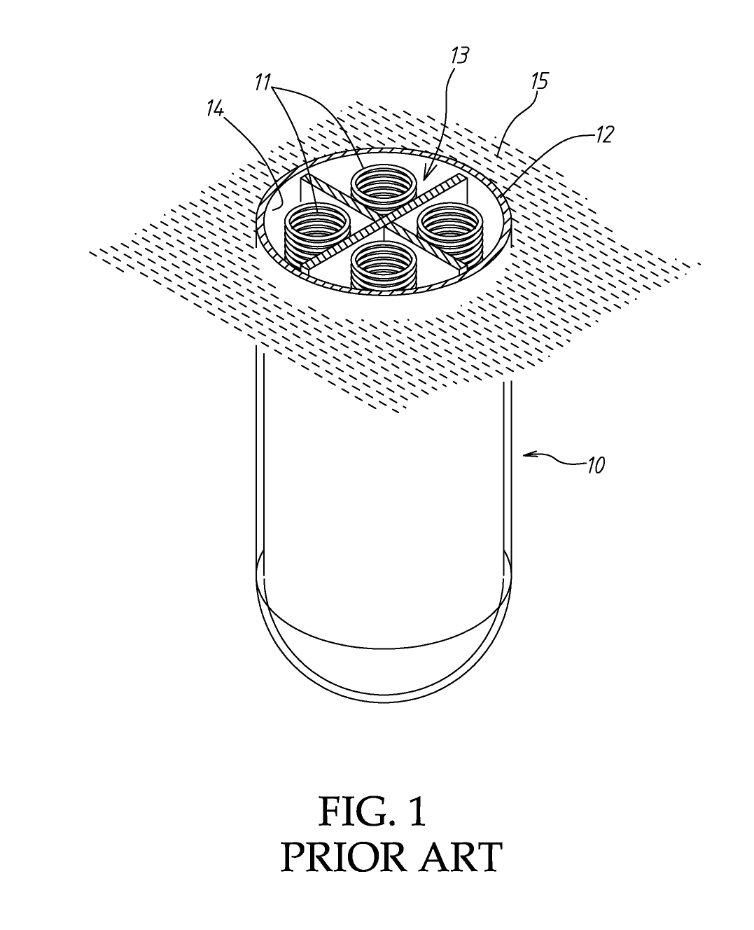

FIG. 2 is a perspective view illustrating a heating tube mounted in a casing for water inlet/outlet reversible water heater in accordance with the present invention.

FIG. 3 illustrates an operation status of the heating tube shown in FIG. 2.

FIG. 4 is an oblique top elevational view of the water inlet/outlet reversible water heater in accordance with the present invention.

FIG. 5 is an exploded view of the water inlet/outlet reversible water heater shown in FIG. 4.

### DETAILED DESCRIPTION OF THE PREFERRED EMBODIMENT

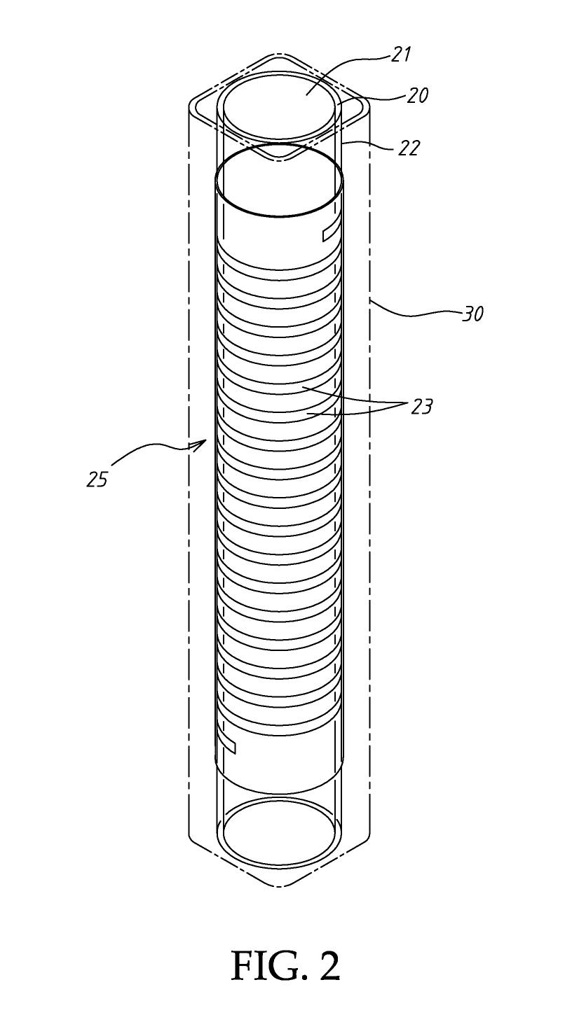

Referring to FIGS. 2, a heating tube 25 for water inlet/outlet reversible water heater in accordance with the present invention is shown. The heating tube 25 comprises a tube body 20 made from a high temperature resistant insulation material (such as glass) and defining therein an axial center hole 21, and a heating element, for example, heating wire 23 (or heating film) surrounding the outer perimeter 22 of the tube body 20. The heating tube 25 can be sealed inside a casing 30 that has a water inlet/outlet located in each of opposing top and bottom sides thereof in communication with the axial center hole 21 of the tube body 20.

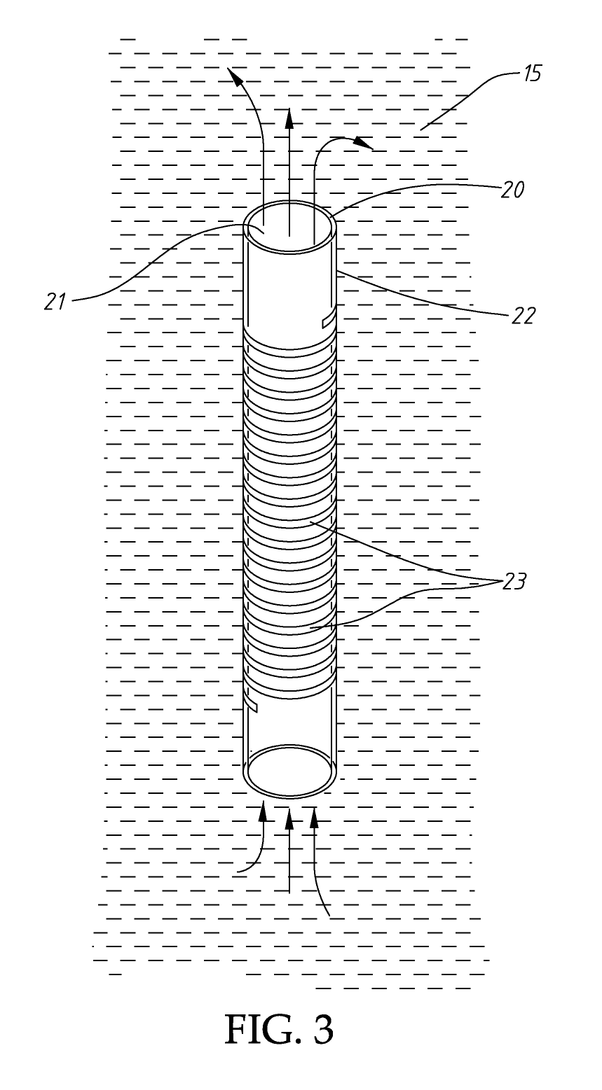

Referring to FIG. 3, after positioning of the heating tube 25 in, for example, an aquarium, the heating element (heating wire) 23 that surrounds the outer perimeter 22 of the tube body 20 is electrically conducted to emit heat through the outer perimeter 22 of the tube body 20. When water 15 is guided through the axial center hole 21 of the tube body 20, it is heated by the heating element (heating wire) 23.

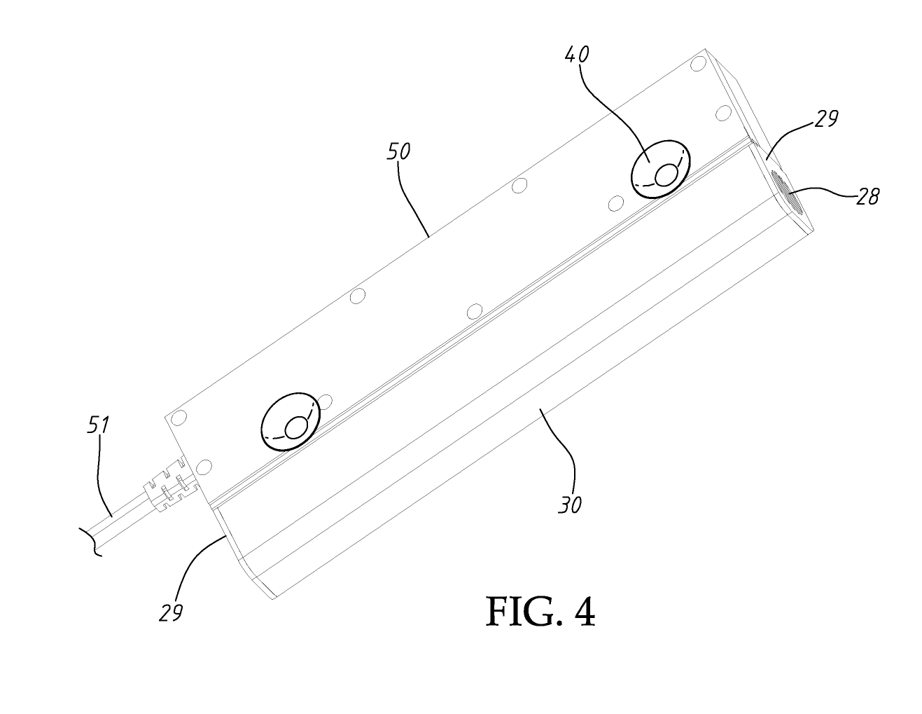

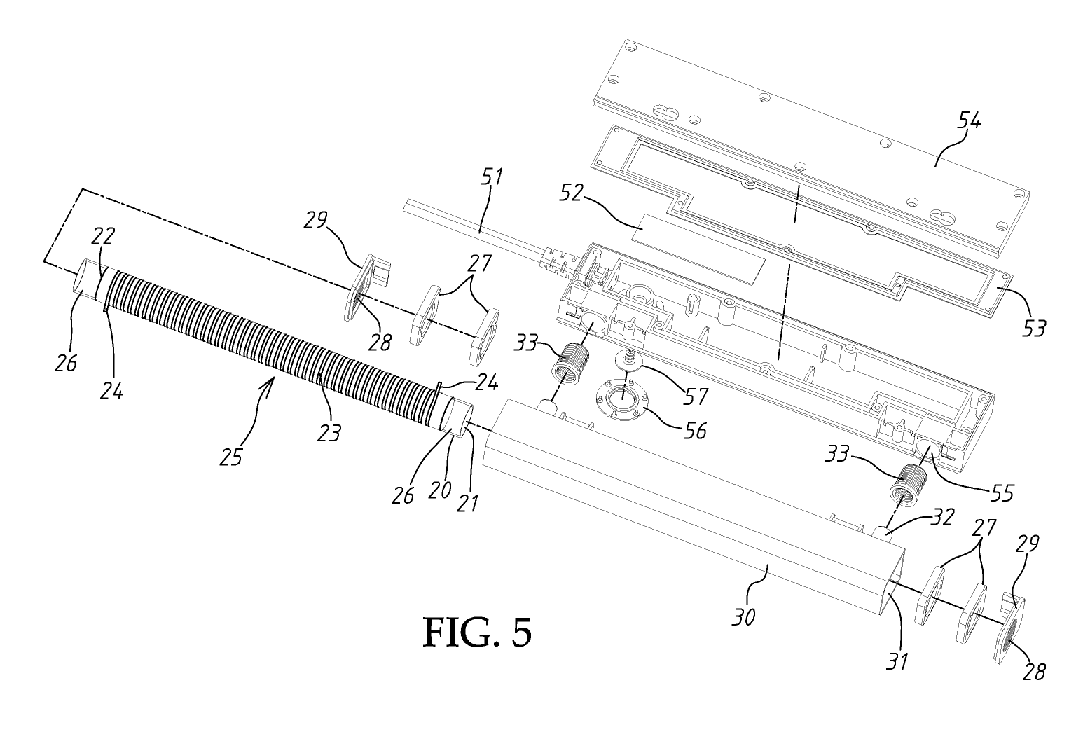

Referring to FIGS. 4 and 5, the heating wire 23 of the heating tube 25 that surrounds the outer perimeter 22 of the tube body 20 has two opposite ends 24 thereof adapted for connection to an external power source. The heating tube 25 is sealed inside a tubular casing 30 that has an axial center hole 31 extending through two opposite ends thereof. The tube body 20 of the heating tube 25 has two opposite ends thereof respectively terminating in a respective positioning portion 26. The two opposing positioning portions 26 of the heating tube 25 are respectively mounted with multiple gasket rings 27 and positioned with the attached gasket rings 27 in the inside wall of the casing 30 around the axial center hole 31 to seal the gap between the outer diameter of the heating tube 25 and the inner diameter of the casing 30. Further, two end caps 29 are respectively capped on the two opposite ends of the casing 30 to prohibit living beings in the aquarium from entering the casing 30 and the heating tube 25. Further, each end cap 29 defines therein a water hole 28 in communication with the axial center hole 21 of the tube body 20. The water hole 28 can be selectively defined as a water inlet or outer outlet.

As illustrated in FIGS. 4 and 5, the casing 30 with the loaded heating tube 25 are attached to an external circuit control device 50 that is equipped with vacuum mounts 40 that can be fastened to an inside wall of an aquarium. The circuit control device 50 is configured to fit the configuration of the casing 30, comprising a power cable 51 located at one end thereof, a circuit board 52 mounted on the inside, and opposing water-sealing bottom cover 53 and top cover 54 respectively covered on opposing top and bottom sides thereof in a watertight manner. Further, a water-sealing glue can be applied to the circuit control device 50 to seal gaps among component parts thereof. Further, the casing 30 and the circuit control device 50 are fastened together by plugging respective plug rods 32 at the casing 30 into respective plug holes 55 at the circuit control device 50. Further, gasket rings 33 are respectively mounted in between the respective plug rods 32 and the respective plug holes 55. The circuit control device 50 further comprises a scale disk 56 and a regulator knob 57 for controlling the regulation of the heating temperature.

In operation, water 15 is guided through the water holes 28 of the end caps 29 and the axial center hole 21 of the tube body 20, and heated efficiently and economically by the heat energy that is released by the heating element (heating wire or heating film) 23 and transferred through the peripheral wall of the tube body 20. Further, because the related control circuit is disposed outside the heating tube 25, the related control circuit will not be damaged easily, and thus, the lifespan of the water inlet/outlet reversible water heater can be significantly prolonged.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A water inlet/outlet reversible water heater, comprising a heating tube, said heating tube comprising a tube body made from a high temperature resistant insulation material and defining therein an axial center hole and a heating element surrounding the outer perimeter of said tube body, and a casing holding said heating tube therein, said casing having a water hole located in each of two opposite ends thereof in communication with said axial center hole of said tube body for the passing of a fluid therethrough.

2. The water inlet/outlet reversible water heater as claimed in claim 1, wherein said casing comprises an axial center hole extended through two opposing ends thereof, and two end caps respectively capped on the two opposite ends thereof, each said end cap defining therein one said water hole in communication with the axial center hole of said tube body of said heating tube; said tube body of said heating tube comprises two positioning portions respectively extended from two opposite ends thereof and positioned in the axial center hole of said casing, and a plurality of gasket rings respectively mounted around said positioning portions and abutted against an inside wall of said casing to seal the gap between said casing and said tube body of said heating tube.

3. The water inlet/outlet reversible water heater as claimed in claim 1, further comprising a circuit control device fastened to an outside wall of said casing outside said heating tube and adapted for controlling the operation of said heating element of said heating tube.

4. The water inlet/outlet reversible water heater as claimed in claim 3, wherein said circuit control device comprises a power cable located at one end thereof for connection to an external power source, a circuit board mounted on the inside, opposing water-sealing bottom cover and top cover respectively covered on opposing top and bottom sides thereof in a watertight manner, and a plurality of plug holes for the mounting of said casing; said casing further comprises a plurality of plug rods extended from the periphery thereof and respectively plugged into said plug holes of said control circuit device, and a plurality of gasket rings mounted in between said plug rods and said plug holes.

5. The water inlet/outlet reversible water heater as claimed in claim 1, wherein said heating element of said heating tube is a heating wire.

6. The water inlet/outlet reversible water heater as claimed in claim 1, wherein said heating element of said heating tube is a heating film.

7. A water inlet/outlet reversible water heater, comprising:
a heating tube, said heating tube comprising a tube body made from a high temperature resistant insulation material and defining therein an axial center hole and a heating element surrounding the outer perimeter of said tube body;
a casing holding said heating tube therein, said casing having a water hole located in each of two opposite ends thereof in communication with said axial center hole of said tube body for the passing of a fluid therethrough; and
a circuit control device fastened to an outside wall of said casing outside said heating tube and adapted for controlling the operation of said heating element of said heating tube.

8. The water inlet/outlet reversible water heater as claimed in claim 7, wherein said casing comprises an axial center hole extended through two opposing ends thereof, and two end caps respectively capped on the two opposite ends thereof, each said end cap defining therein one said water hole in communication with the axial center hole of said tube body of said heating tube; said tube body of said heating tube comprises two positioning portions respectively extended from two opposite ends thereof and positioned in the axial center hole of said casing, and a plurality of gasket rings respectively mounted around said positioning portions and abutted against an inside wall of said casing to seal the gap between said casing and said tube body of said heating tube.

9. The water inlet/outlet reversible water heater as claimed in claim 7, wherein said circuit control device comprises a power cable located at one end thereof for connection to an external power source, a circuit board mounted on the inside, opposing water-sealing bottom cover and top cover respectively covered on opposing top and bottom sides thereof in a watertight manner, and a plurality of plug holes for the mounting of said casing; said casing further comprises a plurality of plug rods extended from the periphery thereof and respectively plugged into said plug holes of said control circuit device, and a plurality of gasket rings mounted in between said plug rods and said plug holes.
